(19) United States
(12) Patent Application Publication
(10) Pub. No.: US 2024/0386074 A1
(43) Pub. Date: Nov. 21, 2024

(54) SYSTEM FOR CONFIGURING AND GATHERING INSTRUMENT TELEMETRY DATA

(71) Applicant: Thermo Finnigan LLC, San Jose, CA (US)

(72) Inventors: Mark Raymond Ressler, Santa fe, NM (US); Stephen Gnanasamy, West Palm Beach, FL (US); Rajesh Raina, Fremont, CA (US); Manish V Doshi, San Jose, CA (US)

(21) Appl. No.: 18/320,845

(22) Filed: May 19, 2023

(51) Int. Cl. G06F 17/40; G06F 17/18

(52) U.S. Cl. CPC G06F 17/40; G06F 17/18

(57) ABSTRACT

Disclosed herein are instrument support systems, as well as related methods, computing devices, and computer-readable media. For example, in some embodiments, an instrument support apparatus may include: first logic to first logic to receive a configuration comprising identifying data related to an instrument that provides telemetry data, and a plurality of settings for the instrument regarding a set of the telemetry data provided by the instrument; second logic to configure a control layer of the instrument to provide the set of the telemetry data according to the plurality of settings; third logic to receive, from the control layer, telemetry data from the set of the telemetry data; fourth logic to format the received telemetry data; and fifth logic to provide the formatted telemetry data for further processing.

### FIELD

Telemetry data includes discrete data measured at a point in time for transmission beyond the location at which the measurement occurred, particularly scalar numerical data representing the value of a property, such as a temperature, but also possibly including the evaluation of a state of a device according to a controlled vocabulary.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 depicts an example system, in accordance with various embodiments.

FIG. 2 is a block diagram of an example support module for configuring a control layer of an instrument, in accordance with various embodiments.

FIG. 3 is a flow diagram of an example method to configure a control layer of an instrument, in accordance with various embodiments.

FIG. 4 is an example of a graphical user interface that may be used in the performance of some or all of the support methods disclosed herein, in accordance with various embodiments.

FIG. 5 is a block diagram of an example computing device that may perform some or all of the instrument support methods disclosed herein, in accordance with various embodiments.

FIG. 6 is a block diagram of an example instrument support system in which some or all of the instrument support methods disclosed herein may be performed, in accordance with various embodiments.

### DETAILED DESCRIPTION

Disclosed herein are instrument support systems, as well as related methods, computing devices, and computer-readable media. For example, in some embodiments, an instrument support apparatus may include: first logic to receive a configuration comprising identifying data related to an instrument that provides telemetry data, and a plurality of settings for the instrument regarding a set of the telemetry data provided by the instrument; second logic to configure a control layer of the instrument to provide the set of the telemetry data according to the plurality of settings; third logic to receive, from the control layer, telemetry data from the set of the telemetry data; fourth logic to format the received telemetry data; and fifth logic to provide the formatted telemetry data for further processing.

The collection of instrument telemetry data (e.g., instrument health data) is important for providing excellent service to client, both in tracking adverse events that occur on the instrument as well as creating predictive models that can anticipate potential problems before they occur. Each instrument has a distinctly different set of properties and events that need to be tracked, so even if there is a common data model according to which the instrument telemetry data is presented, each instrument would typically need to have custom code written to gather and transmit this data. The described systems and methods provide a mechanism according to which a common service can be deployed for multiple instrument models, whereby the specific properties and events that the instrument needs to track can be configured in a specification file, then gathered automatically in a consistent manner, without custom coding.

The described system can be employed to gather telemetry data from instruments in a generic manner without writing custom software for each specific instrument. As described herein, in some embodiment, the system employs a common service that takes advantage of a common API to create a specification protocol according to which various instrument models can configure what instrument telemetry properties and events need to be gathered to track instrument health. The described system provides for the rapid deployment of instrument telemetry data management for new instruments while also aligning to common standards for instrument telemetry data.

In some embodiments, the described systems and methods are employed to interface with an instrument (e.g., a scientific instrument) and collect telemetry data from the instrument. Generally, the described system provides a common service (via a data gathering layer) that gathers, for example, instrument telemetry data based on the configuration of specific properties and events within a specification file that is initialized against the service. In some embodiments, the service gathers that instrument telemetry data using a common instrument communication protocol and then transmits that data according to a standard format (e.g., provide a notification when an error is detected).

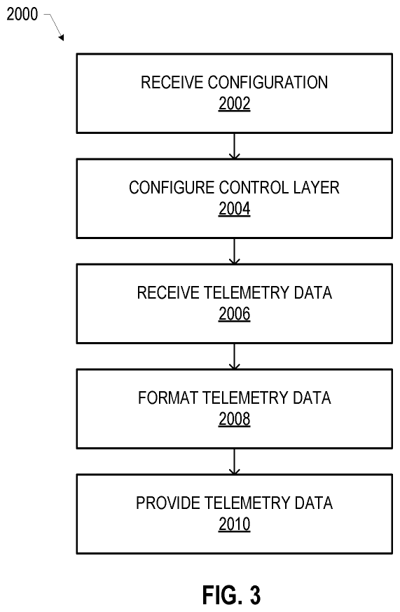

Generally, telemetry data includes measurable qualities that can be reduced to a numerical metric. This telemetry data may include, for example, temperature, pressure, state/health of the instrument, voltage and other electrical metrics of components, number of specific activities or operations performed, amount of consumables consumed, and the like. In some embodiments, the system interfaces with an instrument via a data gathering layer (see FIG. 3). In some embodiments, the telemetry data is received from the instrument in an open format.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

### Example System

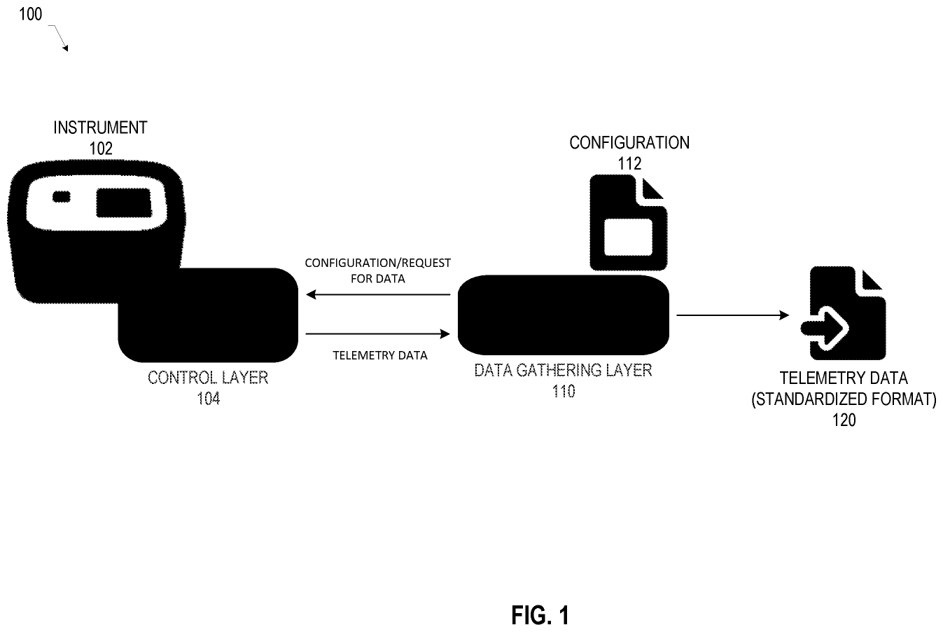

FIG. 1 depicts an example system 100, according to aspects of the disclosure. As depicted, the example system includes an instrument 103 having a control layer 104, a data gathering layer 110, a configuration 112, and telemetry data 120. In some embodiments, the instrument 103 is a scientific instrument, which is a device for performing scientific observations, particularly for performing measurements, but also including optical observations, such as through a microscope. Generally, any device from which telemetry can be taken may be employed in such a system as the instrument 103.

As described above, in some embodiments, the data gathering layer 110 configures the control layer 104 of the instrument 102 to provide telemetry data 120. In some embodiments, the control layer 104 is configured to gather the necessary telemetry, and the data gathering layer 110 accesses the properties or affordances that are configured (in the control layer 104) to pull the telemetry data 120. In some embodiments, the telemetry data 120 is linked with a timestamp or a range of time (e.g., over which the data was collected or during which a state active). In some embodiments, the telemetry data 120 is linked to a unit of measure (e.g., temperature, pressure, voltage, volume, and the like) so that it can be interpreted. In some embodiments, the telemetry data 120 includes information related to an event. In some embodiments, such an event may be internal to the instrument (e.g., a state or an error was thrown) or external to the instrument (e.g., occurrence was detected by the instrument).

In some embodiments, the configuration 112 (retrieved from a configuration/data file) includes parameters controlling the operation of some hardware or software. In some embodiments, the configuration 112 includes, for example, information related to the instrument (e.g., type of device, network address, instrument model, and the like), the properties to collect (types of telemetry data, events, states, activities, settings, and the like), trigger conditions (e.g., collect a particular set of telemetry data when a condition is met), and protocol and properties for communication with the control layer on the instrument. In some embodiments, the configuration 112 defines what telemetry will be gathered from the instrument 102, under what conditions, and which properties will be called via a communication protocol to gather that telemetry. In some embodiments, the configuration 112 includes business logic that would otherwise be embedded in application code.

In some embodiments, the configuration 112 is stored to and read from a configuration file. However, it is contemplated that the data gathering layer 110 may receive or retrieve the configuration 112 to set up and communicate with a particular instrument through a variety of options (e.g., data store, firmware, via a device over a network, and the like).

As depicted, the data gathering layer 110 interfaces with the control layer 104 on the instrument 102. In some embodiments, the control layer 104 is configured for available properties and events. In some embodiments, the data gathering layer 110 adjusts the control layer 104, according to the configuration 112, to monitor properties or to trigger events not already monitored to triggered (e.g., according to the default device settings).

In some embodiments, both the data gathering layer 110 and the control layer 104 are executed by the instrument 102 or a separate device, such as the computing device 4000 of FIG. 5. In some embodiments, the data gathering layer 110 is executed by a separate device while the control layer 104 is executed by the instrument 102. In some embodiments, once the data gathering layer 110 has configured the instrument 102/control layer 104, the data gathering layer 110 passively receives telemetric data (as well as the related timestamp and unit of measure) and events from the control layer 104. In some embodiments, however, the data gathering layer 110 actively queries the control layer 104 (e.g., according to a polling period set in the configuration 112) to provide a particular set of telemetry data.

In some embodiments, the data gathering layer 110 communicates with the control layer 104 via a communication protocol, such as, for example REST ATP, HTTP REST, OPC/UA, MQTT, CoAP and the like. In some embodiments, the data gathering layer 110 receives the configuration 112 to communicate with the instrument 102.

Once collected from the instrument 102, in some embodiments, the data gathering layer 110 is configured to provide the telemetry data 120 in a standard format (e.g., telemetry file, database, electronic message) for further processing or display. In some embodiments, raw telemetry data from the instrument 102 is aggregated over time by the data gathering layer 110 to provide statistical measures over that period including, for example, minimum, maximum, mean, counts, standard deviation, and the like. Standard format includes not only the transmission method, but also the standards for presenting the data, such as OpenTelemetry or custom formats (including proprietary standards).

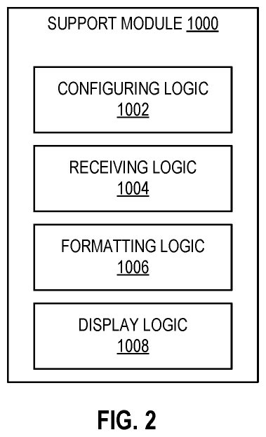

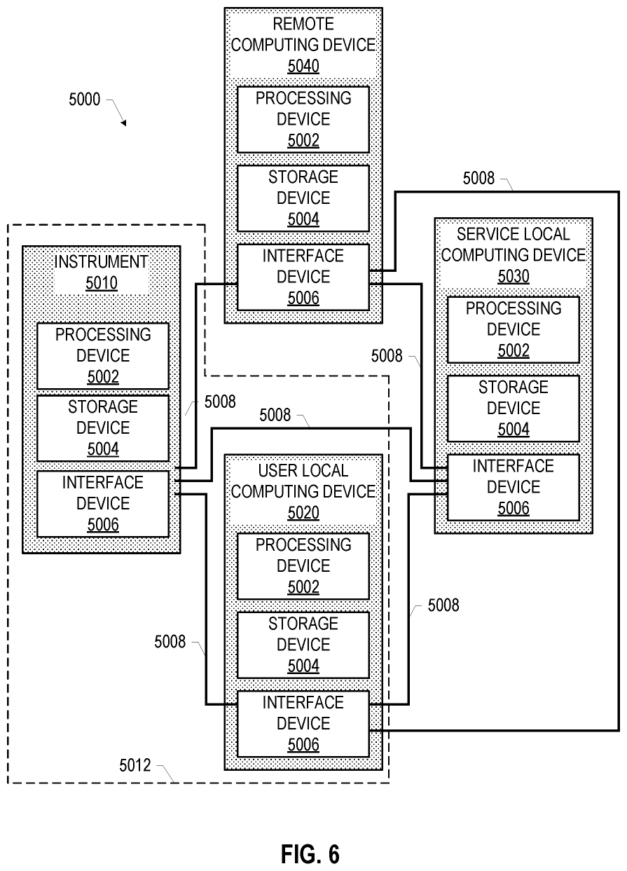

FIG. 2 is a block diagram of a support module 1000 for performing support operations, in accordance with various embodiments (such as the data gathering layer 110 of FIG. 1). The support module 1000 may be implemented by circuitry (e.g., including electrical and/or optical components), such as a programmed computing device. The logic of the support module 1000 may be included in a single computing device or may be distributed across multiple computing devices that are in communication with each other as appropriate. Examples of computing devices that may, singly or in combination, implement the support module 1000 are discussed herein with reference to the computing device 4000 of FIG. 5, and examples of systems of interconnected computing devices, in which the support module 1000 may be implemented across one or more of the computing devices, is discussed herein with reference to the instrument support system 5000 of FIG. 6.

The support module 1000 may include configuring logic 1002, receiving logic 1004, formatting logic 1006, and display logic 1008. As used herein, the term “logic” may include an apparatus that is to perform a set of operations associated with the logic. For example, any of the logic elements included in the support module 1000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform one or more functions associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The configuring logic 1002 may be configured to receive a configuration that includes information related to an instrument (such as instrument 102 of FIG. 1) and settings for the instrument regarding telemetry data provided by the instrument. In some embodiments, the configuration is retrieved from a configuration file. In some embodiments, configuring logic 1002 configures a control layer (such as the control layer 104 of FIG. 1) based on the configuration. As noted above with reference to FIG. 1, in some embodiments, the configuring logic 1002 configures the control layer to provide telemetry data according to the settings provided in the configuration. In some embodiments, the configuring logic 1002 accesses the properties or affordances that are configured in the control layer to pull the telemetry data.

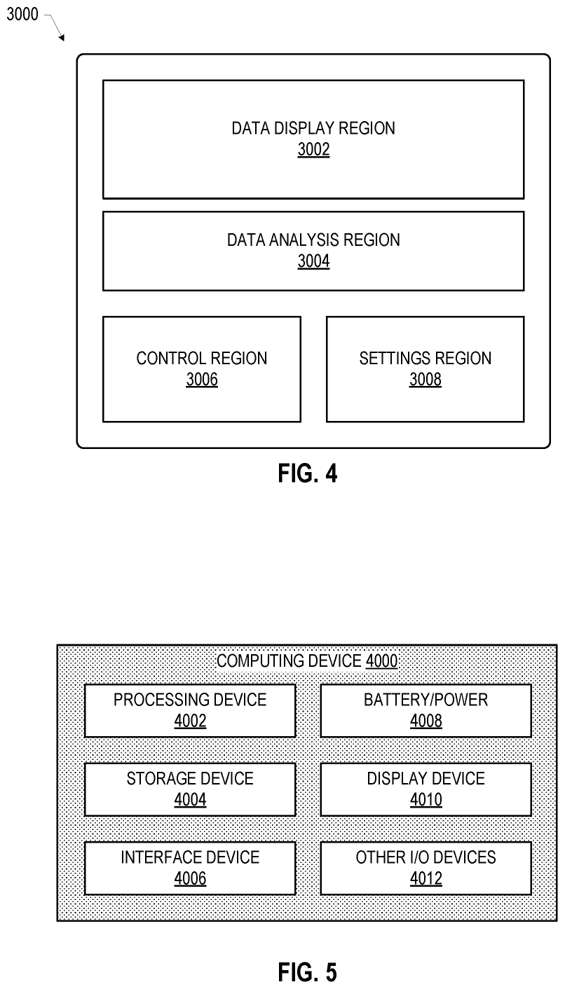

Once the configuring logic 1002 has configured the control layer, the receiving logic 1004 may be configured to receive the telemetry data provided via the control layer of the instrument. The formatting layer 1006 formats the received telemetry data according to a standard format and provides for further processing or display by the display logic 1008. The display logic 1008 may provide to a user, through a GUI (such as the GUI 3000 of FIG. 4), an option to view or interact with the formatted telemetry data.

FIG. 3 depicts a flow diagram of a method 2000 of performing support operations, in accordance with various embodiments. Although the operations of the method 2000 may be illustrated with reference to particular embodiments disclosed herein (e.g., the data gathering layer 110 discussed herein with reference to FIG. 1, the support modules 1000 discussed herein with reference to FIG. 1, the GUI 3000 discussed herein with reference to FIG. 4, the computing device 4000 discussed herein with reference to FIG. 5, and/or the instrument support system 5000 discussed herein with reference to FIG. 6), the method 2000 may be used in any suitable setting to perform any suitable support operations. Operations are illustrated once each and in a particular order in FIG. 3, but the operations may be reordered and/or repeated as desired and appropriate (e.g., different operations performed may be performed in parallel, as suitable).

At 2002, first operations may be performed. For example, configuring logic 1002 of the support module 1000 may perform the operations of 2002. The first operations may include receiving a configuration comprising identifying data related to an instrument that provides telemetry data, and a plurality of settings for the instrument regarding a set of the telemetry data provided by the instrument.

At 2004, second operations may be performed. For example, configuring logic 1002 of the support module 1000 may perform the operations of 2004. The second operations may include configuring a control layer of the instrument to provide the set of the telemetry data according to the plurality of settings.

At 2006, third operations may be performed. For example, receiving logic 1004 of the support module 1000 may perform the operations of 2006. The third operations may include receiving, from the control layer, telemetry data from the set of the telemetry data.

At 2008, fourth operations may be performed. For example, formatting logic 1006 of the support module 1000 may perform the operations of 2008. The fourth operations may include formatting the received telemetry data.

At 2010, fifth operations may be performed. For example, the support module 1000 may perform the operations of 2010. The fifth operations may include providing the formatted telemetry data for further processing.

The instrument support methods disclosed herein may include interactions with a human user (e.g., via the user local computing device 5020 discussed herein with reference to FIG. 6). These interactions may include providing information to the user (e.g., telemetry data related to the operation of an instrument such as the instrument 5010 of FIG. 6, or other information) or providing an option for a user to input commands (e.g., to control the operation of an instrument such as the instrument 5010 of FIG. 6, or to control the analysis of data generated by an instrument), queries (e.g., to a local or remote database), or other information. In some embodiments, these interactions may be performed through a graphical user interface (GUI) that includes a visual display on a display device (e.g., the display device 4010 discussed herein with reference to FIG. 5) that provides outputs to the user and/or prompts the user to provide inputs (e.g., via one or more input devices, such as a keyboard, mouse, trackpad, or touchscreen, included in the other I/O devices 4012 discussed herein with reference to FIG. 5). The instrument support systems disclosed herein may include any suitable GUIs for interaction with a user.

FIG. 4 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 5) of a computing device (e.g., the computing device 4000 discussed herein with reference to FIG. 5) of an instrument support system (e.g., the instrument support system 5000 discussed herein with reference to FIG. 6), and a user may interact with the GUI 3000 using any suitable input device (e.g., any of the input devices included in the other I/O devices 4012 discussed herein with reference to FIG. 5) and input technique (e.g., movement of a cursor, motion capture, facial recognition, gesture detection, voice recognition, actuation of buttons, etc.).

The GUI 3000 may include a data display region 3002, a data analysis region 3004, an instrument control region 3006, and a settings region 3008. The particular number and arrangement of regions depicted in FIG. 4 is simply illustrative, and any number and arrangement of regions, including any desired features, may be included in a GUI 3000. The data display region 3002 may display data generated by an instrument (e.g., telemetry data 120 discussed herein with reference to FIG. 1).

The data analysis region 3004 may display the results of data analysis (e.g., the results of analyzing the data illustrated in the data display region 3002 and/or other data). For example, the data analysis region 3004 may display state information that includes the telemetry data provided by an instrument. In some embodiments, the data display region 3002 and the data analysis region 3004 may be combined in the GUI 3000 (e.g., to include data output from an instrument, and some analysis of the data, in a common graph or region).

The instrument control region 3006 may include options that allow the user to control an instrument (e.g., the instrument 102 discussed herein with reference to FIG. 1 or the instrument 5010 discussed herein with reference to FIG. 6). The settings region 3008 may include options that allow the user to control the features and functions of the GUI 3000 (and/or other GUls) and/or perform common computing operations with respect to the data display region 3002 and data analysis region 3004 (e.g., saving data on a storage device, such as the storage device 4004 discussed herein with reference to FIG. 5, sending data to another user, labeling data, etc.).

As noted above, the support module 1000 may be implemented by one or more computing devices. FIG. 5 is a block diagram of a computing device 4000 that may perform some or all of the instrument support methods disclosed herein, in accordance with various embodiments. In some embodiments, the support module 1000 may be implemented by a single computing device 4000 or by multiple computing devices 4000. Further, as discussed below, a computing device 4000 (or multiple computing devices 4000) that implements the support module 1000 may be part of one or more of the instrument 5010, the user local computing device 5020, the service local computing device 5030, or the remote computing device 5040 of FIG. 6.

The computing device 4000 of FIG. 5 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 5, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, and the like., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra-mobile personal computer, etc.), a desktop computing device, or a server computing device or other networked computing component.

One or more computing devices implementing any of the support modules or methods disclosed herein may be part of an instrument support system. FIG. 6 is a block diagram of an example instrument support system 5000 in which some or all of the instrument support methods disclosed herein may be performed, in accordance with various embodiments. The support modules and methods disclosed herein (e.g., the support module 1000 of FIG. 2 and the methods 2000 and 2100 of FIGS. 3A and 3B respectively as well as the data collection layer 110 and the control layer 104 of FIG. 1) may be implemented by one or more of the instrument 5010, the user local computing device 5020, the service local computing device 5030, or the remote computing device 5040 of the instrument support system 5000.

Any of the instrument 5010, the user local computing device 5020, the service local computing device 5030, or the remote computing device 5040 may include any of the embodiments of the computing device 4000 discussed herein with reference to FIG. 5, and any of the instrument 5010, the user local computing device 5020, the service local computing device 5030, or the remote computing device 5040 may take the form of any appropriate ones of the embodiments of the computing device 4000 discussed herein with reference to FIG. 5.

The instrument 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 4, and the processing devices 5002 included in different ones of the instrument 5010, the user local computing device 5020, the service local computing device 5030, or the remote computing device 5040 may take the same form or different forms. The storage device 5004 may take any suitable form, including the form of any of the storage devices 5004 discussed herein with reference to FIG. 4, and the storage devices 5004 included in different ones of the instrument 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 4, and the interface devices 5006 included in different ones of the instrument 5010, the user local computing device 5020, the service local computing device 5030, or the remote computing device 5040 may take the same form or different forms.

The instrument 5010, the user local computing device 5020, the service local computing device 5030, and the remote computing device 5040 may be in communication with other elements of the instrument support system 5000 via communication pathways 5008. The communication pathways 5008 may communicatively couple the interface devices 5006 of different ones of the elements of the instrument support system 5000, as shown, and may be wired or wireless communication pathways (e.g., in accordance with any of the communication techniques discussed herein with reference to the interface devices 4006 of the computing device 4000 of FIG. 5). The particular instrument support system 5000 depicted in FIG. 6 includes communication pathways between each pair of the instrument 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the instrument 5010, but may instead communicate with the instrument 5010 via the communication pathway 5008 between the service local computing device 5030 and the user local computing device 5020 and the communication pathway 5008 between the user local computing device 5020 and the instrument 5010.

The instrument 5010 may include any appropriate instrument (e.g., a scientific instrument). The user local computing device 5020 may be a computing device (e.g., in accordance with any of the embodiments of the computing device 4000 discussed herein) that is local to a user of the instrument 5010. In some embodiments, the user local computing device 5020 may also be local to the instrument 5010, but this need not be the case; for example, a user local computing device 5020 that is in a user's home or office may be remote from, but in communication with, the instrument 5010 so that the user may use the user local computing device 5020 to control and/or access data from the instrument 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the instrument 5010. For example, the service local computing device 5030 may be local to a manufacturer of the instrument 5010 or to a third-party service company. In some embodiments, the service local computing device 5030 may communicate with the instrument 5010, the user local computing device 5020, and/or the remote computing device 5040 (e.g., via a direct communication pathway 5008 or via multiple “indirect” communication pathways 5008, as discussed above) to receive data regarding the operation of the instrument 5010, the user local computing device 5020, and/or the remote computing device 5040 (e.g., the results of self-tests of the instrument 5010, calibration coefficients used by the instrument 5010, the measurements of sensors associated with the instrument 5010, etc.). In some embodiments, the service local computing device 5030 may communicate with the instrument 5010, the user local computing device 5020, and/or the remote computing device 5040 (e.g., via a direct communication pathway 5008 or via multiple “indirect” communication pathways 5008, as discussed above) to transmit data to the instrument 5010, the user local computing device 5020, and/or the remote computing device 5040 (e.g., to update programmed instructions, such as firmware, in the instrument 5010, to initiate the performance of test or calibration sequences in the instrument 5010, to update programmed instructions, such as software, in the user local computing device 5020 or the remote computing device 5040, etc.). A user of the instrument 5010 may utilize the instrument 5010 or the user local computing device 5020 to communicate with the service local computing device 5030 to report a problem with the instrument 5010 or the user local computing device 5020, to request a visit from a technician to improve the operation of the instrument 5010, to order consumables or replacement parts associated with the instrument 5010, or for other purposes.

The remote computing device 5040 may be a computing device (e.g., in accordance with any of the embodiments of the computing device 4000 discussed herein) that is remote from the instrument 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the instrument 5010, perform analyses of the data generated by the instrument 5010 (e.g., in accordance with programmed instructions), facilitate communication between the user local computing device 5020 and the instrument 5010, and/or facilitate communication between the service local computing device 5030 and the instrument 5010.

In some embodiments, one or more of the elements of the instrument support system 5000 illustrated in FIG. 6 may not be present. Further, in some embodiments, multiple ones of various ones of the elements of the instrument support system 5000 of FIG. 6 may be present. For example, an instrument support system 5000 may include multiple user local computing devices 5020 (e.g., different user local computing devices 5020 associated with different users or in different locations). In another example, an instrument support system 5000 may include multiple instruments 5010, all in communication with service local computing device 5030 and/or a remote computing device 5040; in such an embodiment, the service local computing device 5030 may monitor these multiple instruments 5010, and the service local computing device 5030 may cause updates or other information may be “broadcast” to multiple instruments 5010 at the same time. Different ones of the instruments 5010 in an instrument support system 5000 may be located close to one another (e.g., in the same room) or farther from one another (e.g., on different floors of a building, in different buildings, in different cities, and the like.). In some embodiments, an instrument 5010 may be connected to an Internet-of-Things (IoT) stack that allows for command and control of the instrument 5010 through a web-based application, a virtual or augmented reality application, a mobile application, and/or a desktop application. Any of these applications may be accessed by a user operating the user local computing device 5020 in communication with the instrument 5010 by the intervening remote computing device 5040. In some embodiments, an instrument 5010 may be sold by the manufacturer along with one or more associated user local computing devices 5020 as part of a local instrument computing unit 5012.

In some such embodiments, the remote computing device 5040 and/or the user local computing device 5020 may combine data from different types of instruments 5010 included in an instrument support system 5000.

The following paragraphs provide various examples of the embodiments disclosed herein.

Example 1 is an instrument support apparatus that includes first logic to receive a configuration comprising identifying data related to an instrument that provides telemetry data, and a plurality of settings for the instrument regarding a set of the telemetry data provided by the instrument; second logic to configure a control layer of the instrument to provide the set of the telemetry data according to the plurality of settings; third logic to receive, from the control layer, telemetry data from the set of the telemetry data; fourth logic to format the received telemetry data; and fifth logic to provide the formatted telemetry data for further processing.

Example 2 includes the subject matter of Example 1, and further specifies that the second logic configures the control layer to provide the set of the telemetry data differently than a respective default setting.

Example 3 includes the subject matter of any of Examples 1 and 2, and further specifies that the control layer is configured, according to the plurality of settings, to provide the set of the telemetry data according to a default setting.

Example 4 includes the subject matter of any of Examples 1-3, and further specifies that the second logic configures the control layer to provide the set of the telemetry data in a particular format.

Example 5 includes the subject matter of any of Examples 1-4, and further specifies that the set of telemetry data includes all of the telemetry data provided by the instrument.

Example 6 includes the subject matter of any of Examples 1-5, and further specifies that the third logic is configured to access properties or affordances configured in the control layer to pull the set of the telemetry data.

Example 7 includes the subject matter of any of Examples 1-6, and further specifies that the fourth logic formats the received telemetry data by aggregating the received telemetry data to provide statistical metrics and aligning the received telemetry data to a standard format.

Example 8 includes the subject matter of any of Examples 1-7, and further specifies that the statistical metrics includes minimum, maximum, mean, counts, or standard deviation.

Example 9 includes the subject matter of any of Examples 1-8, and further specifies that the second logic and the third logic are configured to communicate with the instrument via a common communication protocol.

Example 10 includes the subject matter of any of Examples 1-9, and further specifies that the configuration further includes a communication protocol for the instrument.

Example 11 includes the subject matter of any of Examples 1-10, and further specifies that the second logic and the third logic are configured to communicate with the instrument via the communication protocol.

Example 12 includes the subject matter of any of Examples 1-11, and further specifies that the plurality of settings for the instrument include an interval, a threshold, or an internal state of the instrument.

Example 13 includes the subject matter of any of Examples 1-12, and further specifies that the control layer is configured to provide the telemetry data from the set of the telemetry data based on the interval, the threshold, or the internal state of the instrument.

Example 14 includes the subject matter of any of Examples 1-13, and further specifies that the internal state of the instrument includes an error condition.

Example 15 includes the subject matter of any of Examples 1-14, and further specifies that the received telemetry data comprises a numerical metric for a measurable quality.

Example 16 includes the subject matter of any of Examples 1-15, and further specifies that the received telemetry data comprises state information regarding an internal state of the instrument.

Example 17 includes the subject matter of any of Examples 1-16, and further specifies that the instrument is configured to collect environment data related to a surrounding environment.

Example 18 includes the subject matter of any of Examples 1-17, and further specifies that the received telemetry data comprises the environment data.

Example 19 includes the subject matter of any of Examples 1-18, and further specifies that the plurality of settings for the instrument include a configuration related to a condition related to an external event within the surrounding environment.

Example 20 includes the subject matter of any of Examples 1-19, and further specifies that the instrument is configured to collect the environment data in response to a trigger meeting the condition.

Example 21 includes the subject matter of any of Examples 1-20, and further specifies that the received telemetry data comprises a related timestamp or time interval.

Example 22 includes the subject matter of any of Examples 1-21, and further specifies that the received telemetry data comprises a unit of measure.

Example 23 includes the subject matter of any of Examples 1-22, and further specifies that the received telemetry data comprises a health status of the instrument.

Example 24 includes the subject matter of any of Examples 1-23, and further specifies that the instrument comprises a scientific instrument.

Example 25 includes the subject matter of any of Examples 1-24, and further specifies that the configuration is retrieved from a configuration file.

Example 26 is a method, executed by a processing device, for providing scientific

instrument support. The method includes receiving a configuration comprising identifying data related to an instrument that provides telemetry data, and a plurality of settings for the instrument regarding a set of the telemetry data provided by the instrument; configuring a control layer of the instrument to provide the set of the telemetry data according to the plurality of settings and differently than a respective default setting; receiving, from the control layer, telemetry data from the set of the telemetry data; formatting the received telemetry data; and providing the formatted telemetry data for further processing.

Example 27 includes the subject matter of Example 26, and further specifies that the control layer is configured, according to the plurality of settings, to provide the set of the telemetry data according to a default setting.

Example 28 includes the subject matter of any of Examples 26 and 27, and further specifies that the control layer is configured to provide the set of the telemetry data in a particular format.

Example 29 includes the subject matter of any of Examples 26-28, and further specifies that the set of telemetry data includes all of the telemetry data provided by the instrument.

Example 30 includes the subject matter of any of Examples 26-29, and further includes accessing properties or affordances configured in the control layer to pull the set of the telemetry data.

Example 31 includes the subject matter of any of Examples 26-30, and further specifies that the received telemetry data is formatted by aggregating the received telemetry data to provide statistical metrics and aligning the received telemetry data to a standard format.

Example 32 includes the subject matter of any of Examples 26-31, and further specifies that the statistical metrics includes minimum, maximum, mean, counts, or standard deviation.

Example 33 includes the subject matter of any of Examples 26-32, and further includes communicating with the instrument via a common communication protocol.

Example 34 includes the subject matter of any of Examples 26-33, and further specifies that the configuration further includes a communication protocol for the instrument.

Example 35 includes the subject matter of any of Examples 26-34, and further includes communicating with the instrument via the communication protocol.

Example 36 includes the subject matter of any of Examples 26-35, and further specifies that the plurality of settings for the instrument include an interval, a threshold, or an internal state of the instrument.

Example 37 includes the subject matter of any of Examples 26-36, and further specifies that the control layer is configured to provide the telemetry data from the set of the telemetry data based on the interval, the threshold, or the internal state of the instrument.

Example 38 includes the subject matter of any of Examples 26-37, and further specifies that the internal state of the instrument includes an error condition.

Example 39 includes the subject matter of any of Examples 26-38, and further specifies that the received telemetry data comprises a numerical metric for a measurable quality.

Example 40 includes the subject matter of any of Examples 26-39, and further specifies that the received telemetry data comprises state information regarding an internal state of the instrument.

Example 41 includes the subject matter of any of Examples 26-40, and further specifies that the instrument is configured to collect environment data related to a surrounding environment.

Example 42 includes the subject matter of any of Examples 26-41, and further specifies that the received telemetry data comprises the environment data.

Example 43 includes the subject matter of any of Examples 26-42, and further specifies that the plurality of settings for the instrument include a configuration related to a condition related to an external event within the surrounding environment.

Example 44 includes the subject matter of any of Examples 26-43, and further specifies that the instrument is configured to collect the environment data in response to a trigger meeting the condition.

Example 45 includes the subject matter of any of Examples 26-44, and further specifies that the received telemetry data comprises a related timestamp or time interval.

Example 46 includes the subject matter of any of Examples 26-45, and further specifies that the received telemetry data comprises a unit of measure.

Example 47 includes the subject matter of any of Examples 26-46, and further specifies that the received telemetry data comprises a health status of the instrument.

Example 48 includes the subject matter of any of Examples 26-47, and further specifies that the instrument comprises a scientific instrument.

Example 49 includes the subject matter of any of Examples 26-48, and further specifies that the configuration is retrieved from a configuration file.

Example 50 is an instrument support system that includes an instrument that provides telemetry data, the instrument having a control layer and a processing device. The processing device is configured to receive a configuration comprising identifying data related to the instrument, and a plurality of settings for the instrument regarding a set of the telemetry data provided by the instrument; configure the control layer to provide the set of the telemetry data according to the plurality of settings; receive, from the control layer, telemetry data from the set of the telemetry data; format the telemetry data; and provide the formatted telemetry data for further processing.

Example 51 includes the subject matter of Example 50, and further specifies that the second logic configures the control layer to provide the set of the telemetry data differently than a respective default setting.

Example 52 includes the subject matter of any of Examples 50 and 51, and further specifies that the control layer is configured, according to the plurality of settings, to provide the set of the telemetry data according to a default setting.

Example 53 includes the subject matter of any of Examples 50-52, and further specifies that the second logic configures the control layer to provide the set of the telemetry data in a particular format.

Example 54 includes the subject matter of any of Examples 50-53, and further specifies that the set of telemetry data includes all of the telemetry data provided by the instrument.

Example 55 includes the subject matter of any of Examples 50-54, and further specifies that the third logic is configured to access properties or affordances configured in the control layer to pull the set of the telemetry data.

Example 56 includes the subject matter of any of Examples 50-55, and further specifies that the fourth logic formats the received telemetry data by aggregating the received telemetry data to provide statistical metrics and aligning the received telemetry data to a standard format.

Example 57 includes the subject matter of any of Examples 50-56, and further specifies that the statistical metrics includes minimum, maximum, mean, counts, or standard deviation.

Example 58 includes the subject matter of any of Examples 50-57, and further specifies that the second logic and the third logic are configured to communicate with the instrument via a common communication protocol.

Example 59 includes the subject matter of any of Examples 50-58, and further specifies that the configuration further includes a communication protocol for the instrument.

Example 60 includes the subject matter of any of Examples 50-59, and further specifies that the second logic and the third logic are configured to communicate with the instrument via the communication protocol.

Example 61 includes the subject matter of any of Examples 50-60, and further specifies that the plurality of settings for the instrument include an interval, a threshold, or an internal state of the instrument.

Example 62 includes the subject matter of any of Examples 50-61, and further specifies that the control layer is configured to provide the telemetry data from the set of the telemetry data based on the interval, the threshold, or the internal state of the instrument.

Example 63 includes the subject matter of any of Examples 50-62, and further specifies that the internal state of the instrument includes an error condition.

Example 64 includes the subject matter of any of Examples 50-63, and further specifies that the received telemetry data comprises a numerical metric for a measurable quality.

Example 65 includes the subject matter of any of Examples 50-64, and further specifies that the received telemetry data comprises state information regarding an internal state of the instrument.

Example 66 includes the subject matter of any of Examples 50-65, and further specifies that the instrument is configured to collect environment data related to a surrounding environment.

Example 67 includes the subject matter of any of Examples 50-66, and further specifies that the received telemetry data comprises the environment data.

Example 68 includes the subject matter of any of Examples 50-67, and further specifies that the plurality of settings for the instrument include a configuration related to a condition related to an external event within the surrounding environment.

Example 69 includes the subject matter of any of Examples 50-68, and further specifies that the instrument is configured to collect the environment data in response to a trigger meeting the condition.

Example 70 includes the subject matter of any of Examples 50-69, and further specifies that the received telemetry data comprises a related timestamp or time interval.

Example 71 includes the subject matter of any of Examples 50-70, and further specifies that the received telemetry data comprises a unit of measure.

Example 72 includes the subject matter of any of Examples 50-71, and further specifies that the received telemetry data comprises a health status of the instrument.

Example 73 includes the subject matter of any of Examples 50-72, and further specifies that the instrument comprises a scientific instrument.

Example 74 includes the subject matter of any of Examples 50-73, and further specifies that the configuration is retrieved from a configuration file.

1. An instrument support apparatus, comprising:
first logic to receive a configuration comprising identifying data related to an instrument that provides telemetry data, and a plurality of settings for the instrument regarding a set of the telemetry data provided by the instrument;
second logic to configure a control layer of the instrument to provide the set of the telemetry data according to the plurality of settings;
third logic to receive, from the control layer, telemetry data from the set of the telemetry data;
fourth logic to format the received telemetry data; and
fifth logic to provide the formatted telemetry data for further processing.

2. The instrument support apparatus of claim 1, wherein the second logic configures the control layer to provide the set of the telemetry data differently than a respective default setting.

3. The instrument support apparatus of claim 1, wherein the control layer is configured, according to the plurality of settings, to provide the set of the telemetry data according to a default setting.

4. The instrument support apparatus of claim 1, wherein the second logic configures the control layer to provide the set of the telemetry data in a particular format.

5. The instrument support apparatus of claim 1, wherein the third logic is configured to access properties or affordances configured in the control layer to pull the set of the telemetry data.

6. The instrument support apparatus of claim 1, wherein the fourth logic formats the received telemetry data by aggregating the received telemetry data to provide statistical metrics and aligning the received telemetry data to a standard format.

7. The instrument support apparatus of claim 6, wherein the statistical metrics includes minimum, maximum, mean, counts, or standard deviation.

8. The instrument support apparatus of claim 1, wherein the second logic and the third logic are configured to communicate with the instrument via a common communication protocol.

9. The instrument support apparatus of claim 1, wherein the configuration further includes a communication protocol for the instrument, and wherein the second logic and the third logic are configured to communicate with the instrument via the communication protocol.

10. The instrument support apparatus of claim 1, wherein the plurality of settings for the instrument include an interval, a threshold, or an internal state of the instrument, and wherein the control layer is configured to provide the telemetry data from the set of the telemetry data based on the interval, the threshold, or the internal state of the instrument.

11. The instrument support apparatus of claim 1, wherein the received telemetry data comprises a numerical metric for a measurable quality.

12. The instrument support apparatus of claim 1, wherein the received telemetry data comprises state information regarding an internal state of the instrument.

13. The instrument support apparatus of claim 1, wherein the instrument is configured to collect environment data related to a surrounding environment, wherein the received telemetry data comprises the environment data, wherein the plurality of settings for the instrument include a configuration related to a condition related to an external event within the surrounding environment, and wherein the instrument is configured to collect the environment data in response to a trigger meeting the condition.

14. The instrument support apparatus of claim 1, wherein the received telemetry data comprises a related timestamp or time interval.

15. The instrument support apparatus of claim 1, wherein the received telemetry data comprises a unit of measure or a health status of the instrument.

16. The instrument support apparatus of claim 1, wherein the instrument comprises a scientific instrument.

17. The instrument support apparatus of claim 1, wherein the configuration is retrieved from a configuration file.

18. A method, executed by a processing device, for providing scientific instrument support, the method comprising:
receiving a configuration comprising identifying data related to an instrument that provides telemetry data, and a plurality of settings for the instrument regarding a set of the telemetry data provided by the instrument;
configuring a control layer of the instrument to provide the set of the telemetry data according to the plurality of settings and differently than a respective default setting;
receiving, from the control layer, telemetry data from the set of the telemetry data; and
providing the received telemetry data for further processing.

19. The method of claim 18, further comprising:
before providing the received telemetry data for further processing, formatting the received telemetry data.

20. An instrument support system, comprising:
an instrument that provides telemetry data, the instrument having a control layer; and
a processing device configured to:
receive a configuration comprising identifying data related to the instrument, and a plurality of settings for the instrument regarding a set of the telemetry data provided by the instrument;
configure the control layer to provide the set of the telemetry data according to the plurality of settings;
receive, from the control layer, telemetry data from the set of the telemetry data;
format the telemetry data; and
provide the formatted telemetry data for further processing.
